(19) United States
(12) Patent Application Publication
(10) Pub. No.: US 2013/0245149 A1
(43) Pub. Date: Sep. 19, 2013

(54) DUAL CURE COMPOSITIONS, RELATED HYBRID NANOCOMPOSITE MATERIALS AND DUAL CURE PROCESS FOR PRODUCING SAME

(71) Applicants: Valérie Geiser, Lausanne (CH); Yves Leterrier, Lausanne Vaud (CH); Jan-Anders Edvin Manson, Chexbres Vaud (CH)

(72) Inventors: Valérie Geiser, Lausanne (CH); Yves Leterrier, Lausanne Vaud (CH); Jan-Anders Edvin Manson, Chexbres Vaud (CH)

(73) Assignee: ECOLE POLYTECHNIQUE FEDERALE DE LAUSANNE (EPFL), Lausanne (CH)

(21) Appl. No.: 13/988,449

(22) PCT Filed: Nov. 21, 2011
(86) PCT No.: PCT/IB11/55214

§ 371 Date: Jun. 6, 2013

(30) Foreign Application Priority Data
Nov. 19, 2010 (IB) PCT/IB2010/055308

(51) Int. Cl. C08K 3/36; C08K 5/5425; C09D 133/08

(52) U.S. Cl. CPC C08K 3/36; C09D 133/08; C08K 5/5425
USPC 522/33; 524/261; 522/77; 524/35

(57) ABSTRACT

The present invention concerns a dual cure composition comprising a radiation curable polymer precursor, solid particles, an organometallic precursor and a coupling agent, a hybrid organic/inorganic nanocomposite material produced using said dual cure composition and a dual cure process using thermal energy and radiation for producing the same.

### FIELD OF THE INVENTION

This invention relates to dual cure compositions, hybrid organic/inorganic nanocomposite materials and a dual cure process for producing the hybrid nanocomposite materials.

### BACKGROUND OF THE INVENTION

The use of particulate materials for enhancement of polymer properties dates back to the earliest years of the polymer industry. Initially used as extending agents to reduce the cost of polymer-based products, fillers were soon recognized to overcome the limitations of polymers, such as low stiffness and low strength, and to improve their thermo-mechanical properties. A strong correlation between filler volume and elastic modulus, compressive yield stress, scratch resistance, thermal stability, glass transition temperature, coefficient of thermal expansion, as well as optical and physical properties like gas permeation was demonstrated. The properties of composites with filler dimensions ranging from micrometer to a few millimeters do not profoundly depend on the size of the fillers. If filler dimensions are decreased down to a few nanometers, the effect on properties such as thermal stability and reinforcement becomes much more important. This is a consequence of the extremely large specific interfacial area and very short distance between reinforcing particles.

The last two decades have seen the emergence of so called nanocomposites, where the filler has at least one dimension in the nanometer range. The three families of discrete particle composites that have attracted most attention are carbon nanotube composites, clay nanocomposites, and spherical inorganic particle composites, of which amorphous SiO₂ particle composites are the most common. Already small quantities of nanofillers can have a considerable effect on reinforcement. For example, addition of 0.1% of carbon nanotubes into an epoxy had a measurable effect on reinforcement and 10% of carbon nanotubes in polystyrene increased the storage modulus by 49%. Another advantage of nanocomposites is their transparency to visible and UV light, which is especially important if photo-polymerization is used. Light-curable nanocomposites are in fact increasingly used in numerous applications fields including hard-coatings for displays and automotive components, resists for microtechnologies, composite resins for dental restoration, and so on.

However, the claimed benefits of nanocomposites rely on a good dispersion of the particles, which is usually associated with processing problems. In fact, small amounts of nanoparticles drastically alter the viscoelastic properties of the material, transforming the liquid-like polymer into a solid-like composite paste. The liquid-to-solid transition is a major challenge for nanocomposite processing and is often overcome with the use of solvents.

A solution to overcome processing problems of nanocomposites due to the high viscosity is the use of an organometallic liquid precursor, to form the inorganic phase in situ in the polymer matrix through sol-gel condensation reactions. Sol-gel processing describes the synthesis of an inorganic phase from a liquid organometallic precursor. Metal alkoxides in the form of M(OR)₄, where M is usually Si or Ti, are popular precursors because they react readily with water, and R═CH₂CH₃, but also other ligands are possible. The most common silica precursor is tetraethyl orthosilicate (TEOS). Silicon alkoxides are not very reactive, but their reaction rates can be adjusted by using acid, base or nucleophilic catalysts. The reaction of the titanium alkoxides, on the other hand, is difficult to control. Sol-gel processing was initially only used for the formation of inorganic monolithic structures or hard films. However, this process suffered from drawbacks such as crack formation in coatings, brittleness of sols or high sintering temperatures necessary for complete densification. These limitations were overcome by adding organic modifiers to the inorganic network to promote the elasticity of the gel. For instance the addition of only 5% of star alkoxysilane molecules into the inorganic network during sol-gel synthesis substantially improves the toughness, with a Young's modulus within a factor of 2 of that of the inorganic glass. The modified glass moreover shows much higher energy to break and compression strength.

For sol-gel processing of organic/inorganic hybrids the monomer and a liquid organometallic precursor are mixed in the liquid state, allowing for a very homogeneous distribution of the reactants on a molecular level. Good dispersions are obtained using in situ sol-gel formation of inorganic particles inside the polymerized matrix, in particular in the case of SiO₂ or TiO₂. The pH plays an important role in determining the morphology of the forming silica phase. At pH≧2 hydrolysis is faster than condensation, leading to fine silica particles, whereas at higher pH the particles aggregated. If a low pH is combined with the use of a coupling agent, a very fine silica structure (2-5 nm), intertwined with the polymer network is expected. A coupling agent is a molecule that contains different functional groups that allow on one hand the copolymerization with the organic matrix, and on the other hand the condensation with the silica network. The addition of the coupling agent induces covalent bonds between the organic and inorganic phase, which is crucial to obtain a high performance material. The coupling agent also reduces the size of the inorganic domains by pinning the inorganic phase to the matrix, therefore preventing macroscopic phase separation.

The main drawback of the sol-gel route is the rather long reaction time and elevated temperatures (typically several hours at 80° C. or more) compared with the rapid and low temperature photopolymerization (typically few seconds at 20-30° C.). Even longer cure times are required when applying such materials as protective coatings to thermoplastic substrates with low heat tolerance. Another major issue is shrinkage during drying or from evaporation of byproducts and resulting distortion or cracking due to excessive residual stresses.

### SUMMARY OF THE INVENTION

It is therefore the main object of the present invention to provide a dual cure composition to produce hybrid organic/inorganic nanocomposites with unique combination of properties including transparency, low stress and high thermo-mechanical performance.

The present invention concerns a dual cure composition comprising
a) a radiation curable polymer precursor,
b) solid particles,
c) an organometallic precursor,
d) a coupling agent.

The dual cure composition of the present invention may furthermore comprise a photoinitiator.

The term “dual cure” composition refers to a composition that will cure upon exposure to two different curing processes. For example, the dual cure compositions of the present invention will cure upon exposure to thermal energy and radiation. As used herein, thermal energy is intended to include radiant energy such as infrared or microwave energy and the like; or conductive thermal energy such as that produced by a heated platen or hot air oven, for example. As used herein, the term “radiation” refers to ionizing radiation (e.g., electron beams), infrared radiation and/or actinic light (e.g., UV light).

A radiation curable polymer precursor is a monomer or oligomer, which forms a solid polymer upon curing when exposed to a radiation energy. Radiation cure comprises photopolymerization (usually with UV and blue light, using suitable photoinitiators, PI), infrared (IR) polymerization and electron-beam cross-linking, and can be applied to free-radical polymer precursors and cationic polymer precursors (see Fouassier J. P., Radiation Curing in Polymer Science and Technology: Fundamentals and methods, Springer (1993)).

Free Radical Polymer Precursors

Free radical polymer precursors comprise one or more materials and include acrylates, e.g. mono, bis and higher order functionality acrylates, and comprising urethane, polyether, polyester, polyaromatic, perhydro-aromatic inter links or a mixture thereof, the acrylates preferably comprising at least one acrylate having a functionality of 2 or more; methacrylates, e.g. mono, bis or higher order functionality methacrylates and comprising urethane, polyether, polyester, polyaromatic, perhydro-aromatic inter links or a mixture thereof, and preferably comprising at least one methacrylate with a functionality of at least 2; thiols having two or more thiol groups per molecule, e.g. a polythiol obtained by esterification of a polyol with an alpha, or (3-mercaptocarboxylic acid (such as thioglycolic acid, or (3-mercaptopropionic acid), or pentaerythritol tetramercaptoacetate or pentaerythritol tetrakis-(3-mercaptopropionate (PETMP), and blends thereof such as acrylic-thio blends, additionally containing methacrylics and acrylic-isocyanate blends. Examples of di(meth)acrylates include di(meth)acrylates of cycloaliphatic or aromatic diols such as 1,4-dihydroxymethylcyclohexane, 2,2-bis(4-hydroxy-cyclohexyl)propane, bis(4-hydroxycyclohexyl)methane, hydroquinone, 4,4′-dihydroxybiphenyl, bisphenol A, bisphenol F, bisphenol S, ethoxylated or propoxylated bisphenol A, ethoxylated or propoxylated bisphenol F, and ethoxylated or propoxylated bisphenol S. Alternatively, the di(meth)acrylate may be acyclic aliphatic, rather than cycloaliphatic or aromatic.

Cationic Polymer Precursors

Cationic polymer precursors comprise on or more materials and include epoxies, e.g. glycidyl epoxies of polyglycidyl ethers such as trimethylolpropane triglycidyl ether, triglycidyl ether of polypropoxylated glycerol, and diglycidyl ether of 1,4-cyclohexanedimethanol, and diglycidyl ethers based on bisphenol A and bisphenol F and mixtures thereof, polyglycidyl esters and poly((3-methylglycidyl)esters, and cycloaliphatic epoxies such as bis(2,3-epoxycyclopentyl)ether, 1,2-bis(2,3-epoxycyclopentyloxy)ethane, 3,4-epoxycyclohexyl-methyl 3,4-epoxycyclohexanecarboxylate, 3,4-epoxy-6-methyl-cyclo hexyl methyl 3,4-epoxy-6-methylcyclohexanecarboxylate, di(3,4-epoxycyclohexylmethyl)hexanedioate, di(3,4-epoxy-6-methylcyclohexylmethyl)hexanedioate, ethylenebis(3,4-epoxycyclohexanecarboxylate, ethanediol di(3,4-epoxycyclohexylmethyl)ether, vinylcyclohexane dioxide, dicyclopentadiene diepoxide or 2-3,4epoxycyclohexyl-5,5-spiro-3,4-epoxy)cyclohexane-1,3dioxane, and 2,2′-Bis-(3,4-epoxy-cyclohexyl)-propane, and other epoxy derivatives such as N,N,O-triglycidyl derivative of 4-aminophenol, glycidyl ether/glycidyl esters of salicylic acid, N-glycidyl-N′-(2-glycidyloxypropyl)-5,5-dimethylhydantoin or 2-glycidyloxy-I3-bis(5,5-dimefhyl-Iglycidylhydantoin-3-yl)propane, vinyl cyclohexene dioxide, vinyl cyclohexene monoxide, 3,4-epoxycyclohexlmethyl acrylate, 3,4-epoxy-6-methyl cyclohexylmethyl-9,10-epoxystearate, 1,2-bis(2,3-epoxy-2methylpropoxy)ethane, and the like.

Radiation curable precursors may also comprise on or more materials and include vinylethers, such as bis[4-(vinyloxy)butyl]1,6-hexanediylbiscarbamate, bis[4-(vinyloxy)butyl]isophthalate, bis[4-(vinyloxy)butyl](methylenedi-4,1-phenylene)biscarbamate, bis[4-(vinyloxy)butyl](4-methyl-1,3-phenylene)biscarbamate, bis[4-(vinyloxy)butyl]succinate, bis[4-(vinyloxy)butyl]terephthalate, bis[4-(vinyloxymethyl)cyclohexylmethyl]glutarate, 1,4-butanediol divinyl ether, 1,4-butanediol vinyl ether, butyl vinyl ether, tert-butyl vinyl ether, 2-chloroethyl vinyl ether, 1,4-cyclohexanedimethanol divinyl ether, 1,4-cyclohexanedimethanol vinyl ether, cyclohexyl vinyl ether, di(ethylene glycol)divinyl ether, di(ethylene glycol) vinyl ether, diethyl vinyl orthoformate, dodecyl vinyl ether, ethylene glycol vinyl ether, 2-ethylhexyl vinyl ether, ethyl-1-propenyl ether, mixture of cis and trans, ethyl vinyl ether, isobutyl vinyl ether, propyl vinyl ether, tris[4-(vinyloxy)butyl]trimellitate.

The radiation curable polymer precursor of the dual cure formulation according to the invention can include a combination of free-radical and cationic species, and a number of additional phases and a variety of fillers. Examples of such additional phases include, e.g., modifiers, tougheners, stabilizers, antifoaming agents, leveling agents, thickening agents, flame retardants, antioxidants, pigments, dyes, fillers, and combinations thereof.

Radiation curable polymer precursor may be selected from the group of acrylates, methacrylates, urethane acrylates, unsaturated polyesters, thiol-enes, epoxides and vinylethers.

Hyperbranched Polymers

Radiation curable polymer precursors may be precursors of hyperbranched polymers (HBP). The term HBP used herein refers to dendrimers, hyperbranched polymers and other dendron-based architectures and derivatives of all of them, and their reactive blends with multifunctional polymers. HBPs can generally be described as three-dimensional highly branched molecules having a tree-like structure. They are characterized by a great number of end groups, which can be functionalized with tailored groups to ensure compatibility and reactivity. The dendritic or “tree-like” structure shows regular symmetric branching from a central multifunctional core molecule leading to a compact globular or quasi-globular structure with a large number of end groups per molecule. Hyperbranched polyesters have been described by Malmström et al. (Macromolecules 28, (1997) 1698). Whereas the dendrimers require stepwise synthesis and can be costly and time consuming to produce, hyperbranched polymers can be prepared by a simple condensation of molecules of type ABₘ, and (usually) a B_{f} functional core. This results in an imperfect degree of branching and some degree of polydispersity, depending on the details of the reaction. Hyperbranched polymers nevertheless conserve the essential features of dendrimers, namely a high degree of end-group functionality and a globular architecture, at an affordable cost for bulk applications (Hawker and Frechet, ACS Symp. Ser. 624, (1996) 132; Frechet et al., J. Macromol. Sci-Pure Appl. Chem. A33, (1996) 1399; Tomalia and Durst, Top. Curr. Chem. 165, (1993) 193).

In general, dendritic polymers such as dendrimers and hyperbranched polymers have an average of at least 16 end groups per molecule for 2nd generation materials, increasing by a factor of at least 2 for each successive generation or pseudo-generation, certain dendritic polymers having up to 7 or more generations. The exemplary Boltorn™ polymers used as precursors for the HBPs in the examples provided herein are commercially available up to a 4 pseudo-generations. Number average molar masses of 2 generation or pseudo-generation dendrimers or hyperbranched polymers are usually greater than about 1500 g/mol, and the molar masses increases exponentially in generation or pseudo-generation number, reaching about 8000 g/mol for a 4 pseudo-generation polymer such as 4-generation Boltorn™. Typically the molecular weight of the dendrimers will be about 100 g/mol per end group, although this will vary according to the exact formulation.

The HBPs used in the present invention are therefore distinguished from conventional highly branched polymers which may have as many end groups, but have a much higher molar mass and a much less compact structure. The HBPs are distinguished from compact highly branched species that are produced during intermediate steps in the cure of other radiation curable polymers (epoxy, for example), as these latter polymers have a very broad molar mass distribution and hence an ill-defined molar mass. Dendrimers have a single well-defined molar mass and hyperbranched polymers have well defined molar mass averages and a relatively narrow molecular weight distribution, for example having a polydispersity which is less than 5.0 and more preferably is less than 2.0.

Because of their symmetrical or near symmetrical highly branched structure, HBPs show considerable differences in behaviour to, and considerable advantages over linear or conventional branched polymers, as well as monomers and low molar mass molecules with comparable chemical structures. HBPs can be formulated to give a very high molecular weight but a very low viscosity, making them suitable as components in compositions such as coatings so as to increase the solids content and hence reduce volatiles, whilst maintaining processability. HBPs can be used in the preparation of products constituting or being constituents of alkyd resins, alkyd emulsions, saturated polyesters, unsaturated polyesters, epoxy resins, phenolic resins, polyurethane resins, polyurethane foams and elastomers, binders for radiation curing systems such as systems cured with ultraviolet (UV) light, infrared (IR) light or electron beam irradiation (EB), dental materials, adhesives, synthetic lubricants, microlithographic coatings and resists, binders for powder systems, amino resins, composites reinforced with glass, aramid or carbon/graphite fibers and moulding compounds based on urea-formaldehyde resins, melamine-formaldehyde resins or phenol-formaldehyde resins. By adapting their shell chemistry they can be compatibilised with a given thermoset, photoset or thermoplastic matrix and function simultaneously as processing aids, adhesion promoters, modifiers of interfacial or surface tension, toughening additives or low stress additives. They can be compatibilised with or made reactive with two or more components of a heterogeneous multicomponent polymer-based system to improve adhesion and morphological stability.

Other suitable polymers for the present invention include HBPs modified by grafting linear chain arms to, or growing linear chains from their end groups. More generally, any type of star shaped or star branched polymer, in which linear or branched polymer arms are attached to a multifunctional core, or any related architecture, is suitable for the present application.

Alternative HBP Formulations

The nucleus of the HBP molecule is preferentially selected from a group consisting of a mono, di, tri or poly functional alcohol, a reaction product between a mono, di, tri or poly functional alcohol and ethylene oxide, propylene oxide, butylene oxide, phenylethylene oxide or combinations thereof, a mono, di, tri or poly functional epoxide, a mono, di, tri or poly functional carboxylic acid or anhydride, a hydroxy functional carboxylic acid or anhydride. Constituent mono, di, tri or poly functional alcohols are exemplified by 5-ethyl-5-hydroxymethyl-I3-dioxane, 5,5-dihydroxymethyl-I3-dioxane,ethylene glycol, diethylene glycol, triethylene glycol, propylene glycol, dipropylene glycol, pentanediol, neopentyl glycol, 1,3-propanediol, 2-methyl-2-propyl-I3-propanediol, 2-ethyl-2-butyl-I3-propanediol, cyclohexane-dimethanol, trimethylolpropane, trimethylolethane, glycerol, erythritol, anhydroennea-heptitol, ditrimethylolpropane, ditrimethylolethane, pentaerythritol, methylglucoside, dipentaerythritol, tripentaerythritol, glucose, sorbitol, ethoxylated trimethylolethane, propoxylated trimethylolethane, ethoxylated trimethylolpropane, propoxylated trimethylolpropane, ethoxylated pentaerythritol or propoxylated pentaerythritol.

Chain Termination and Functionalisation of HBPs

Chain termination of a HBP molecule is preferably obtained by addition of at least one monomeric or polymeric chain stopper to the HBP molecule. A chain stopper is then advantageously selected from the group consisting of an aliphatic or cycloaliphatic saturated or unsaturated monofunctional carboxylic acid or anhydride having 1-24 carbon atoms, an aromatic monofunctional carboxylic acid or anhydride, a diisocyanate, an oligomer or an adduct thereof, a glycidyl ester of a monofunctional carboxylic or anhydride having 1-24 carbon atoms, a glycidyl ether of a monofunctional alcohol with 1-24 carbon atoms, an adduct of an aliphatic or cycloaliphatic saturated or unsaturated mono, di, tri or poly functional carboxylic acid or anhydride having 1-24 carbon atoms, an adduct of an aromatic mono, di, tri or poly functional carboxylic acid or anhydride, an epoxide of an unsaturated monocarboxylic acid or corresponding triglyceride, which acid has 3-24 carbon atoms and an amino acid. Suitable chain stoppers are, for example, formic acid, acetic acid, propionic acid, butanoic acid, hexanoic acid, acrylic acid, methacrylic acid, crotonic acid, lauric acid, linseed fatty acid, soybean fatty acid, tall oil fatty acid, dehydrated castor fatty acid, capric acid, caprylic acid, benzoic acid, para-tert.butyl benzoic acid, abietic acid, sorbic acid, 1-chloro-2,3-epoxypropane, 1,4-dichloro-2,3-epoxybutane, epoxidized soybean fatty acid, trimethylol propane diallyl ether maleate, toluene-2,4-diisocyanate, toluene-2,6-diisocyanate, hexamethylene diisocyanate, phenyl isocyanate and/or isophorone diisocyanate. It is emphasized that the aforementioned chain stoppers include compounds with or without functional groups. A functionalization of a dendritic polymer molecule (with or without chain termination) is preferably a nucleophilic addition, anoxidation, an epoxidation using an epihalohydrin such as epichlorohydrin, an allylation using an allylhalide such as allylchloride and/or allyl bromide, or a combination thereof. A suitable nucleophilic addition is, for example, a Michael addition of at least one unsaturated anhydride, such as maleic anhydride. Oxidation is preferably performed by means of an oxidizing agent. Preferred oxidizing agents include peroxy acids or anhydrides and haloperoxy acids or anhydrides, such as peroxyformic acid, peroxyacetic acid, peroxybenzoic acid, m-chloroperoxybenzoic acid, trifluoroperoxyacetic acid or mixtures thereof, or therewith. Oxidation may thus result in, for example, primary and/or secondary epoxide groups. To summarize, functionalization refers to addition or formation of functional groups and/or transformation of one type of functional groups into another type. Functionalization includes nucleophilic addition, such as Michael addition, of compounds having functional groups, epoxidation/oxidization of hydroxyl groups, epoxidation of alkenyl groups, allylation of hydroxyl groups, conversion of an epoxide group to anacrylate or methacrylate group, decomposition of acetals and ketals, grafting and the like.

In a preferred embodiment, the novel dual cure formulations according to the invention are constituted of at least an hyperbranched polymer (HBP). This HBP preferably contains acrylate functions, and is preferably processed with the other precursors using UV light and suitable photoinitiators. The HBP may be chemically modified to impart additional functionality to the material in question, such as fluorescent groups, biologically active groups, compatibilising groups, surface active groups or any other required function, depending on the application in question.

For example, the radiation curable polymer precursor (or radiation curable monomer) is an acrylated hyperbranched polyester or polyether.

Photoinitiators

For radiation cure processing carried out using light sources such as visible or preferably UV light sources the dual cure composition of the present invention may comprise a photoinitiator, selected among the groups of free radical photoinitiators and cationic photoinitiators, or combinations thereof (see Fouassier J. P., Radiation Curing in Polymer Science and Technology: Fundamentals and methods, Springer (1993)).

Suitable free-radical photoinitiator may be benzoins, e.g., benzoin, benzoin ethers such as benzoin methyl ether, benzoin ethyl ether, benzoin isopropyl ether, benzoin phenyl ether, and benzoin acetate; acetophenones, e.g., acetophenone, 2,2-dimethoxyacetophenone, and 1,1-dichloroacetophenone; benzil ketals, e.g., benzil dimethylketal and benzil diethyl ketal; anthraquinones, e.g., 2-methylanthraquinone, 2-ethylanthraquinone, 2-tertbutylanthraquinone, 1-chloroanthraquinone and 2-amylanthraquinone; triphenylphosphine; acylphosphine oxides or benzoylphosphine oxides, e.g., 2,4,6-trimethylbenzoy-diphenylphosphine oxide; bisacylphosphine oxides; benzophenones, e.g., benzophenone and 4,4′-bis(N,N′-di-methylamino)benzophenone; thioxanthones and xanthones; acridine derivatives; phenazine derivatives; quinoxaline derivatives; 1-phenyl-I, 2-propanedione 2-O-benzoyl oxime; 4-hydroxyethoxy)phenyl-(2-propyl)ketone; 1-aminophenyl ketones or 1-hydroxy phenyl ketones, e.g., 1-hydroxycyclohexyl phenyl ketone, 2-hydroxyisopropyl phenyl ketone, phenyl 1-hydroxyisopropyl ketone, and 4-isopropylphenyl 1-hydroxyisopropyl ketone; a titanocene; a borate or a sensitizing colorant. A preferred photoinitiator for formulations based on free radical precursors is 1-hydroxy-cyclohexyl-phenyl-ketone.

Suitable cationic photoinitiator may be onium salts with anions of weak nucleophilicity, e.g., halonium salts, iodosyl salts, sulfonium salts, sulfoxonium salts, diazonium salts and metallocene salts.

In a preferred embodiment, the photoiniator is selected from the group consisting of an alpha-diketone, a benzoin alkyl ether, a thioxanthone, a benzophenone, an acylphosphinoxide, an acetophenone, a ketal, a titanocene, a borate or a sensitizing colorant.

In a more preferred embodiment, the photoinitiator is a benzophenone.

Solid Particles

Solid particles used in the formulation may be of various sizes, preferably below few microns, and of various shapes (spherical, fiber-like, disk-like, etc) and include inorganic and organic particles, and combinations thereof.

Inorganic particles include oxides such as SiO₂, TiO₂, ZrO₂, Al₂O₃, Fe₂O₃, oxide hydrates such as Al(O)OH, nitrides such as Si₃N₄, carbides of Si, Al, B, Ti, or Zr, silicate minerals such as orthosilicates and phyllosilicates or metals such as Au or Co in the shape of spheres, fibers, needles, or platelets. The inorganic particles are preferable metal oxides such as silicon oxide.

Organic particles include carbon particles such as carbon nanotubes and graphene, and carbon-based particles such as cellulose and cellulose derivatives.

The particles may include a surface treatment, for instance to enhance compatibility with the polymer phase. Treatments include the application of organosilanes (primarily for metal oxide particles), plasma treatment (for e.g. cellulose-based fillers). The particles may also be dispersed in an appropriate solvent.

Organometallic Precursor

The organometallic precursors are in liquid form and comprise metal alkoxide compounds or a mixture of compounds with the formula M(OR)ₙ where n is 2 to 4 and M is a metal selected from the group consisting of Si, Ti, Zr, Al, B, Sn, and V and R is an organic moiety selected from the group C₁ to C₆ alkoxy, Cl, Br, I, hydrogen, and C₁ to C₆ acryloxy. These precursors form the inorganic phase in situ in the organic polymer matrix through sol-gel condensation reactions (see Brinker, C. J.; G. W. Scherer, Sol-Gel Science: The Physics and Chemistry of Sol-Gel Processing, Academic Press (1990)).

Preferred metal alkoxide precursor comprise those based on Si and Ti. The most common silica precursor is tetraethyl orthosilicate (TEOS), whose reaction rate can be adjusted by using acid, base or nucleophilic catalysts.

A catalyst for hydrolysis and subsequent condensation of the organometallic precursors can be included in the dual cure formulation as needed. The catalyst can be an acid or a base, but is generally and acid. For example the acid can be nitric acid or hydrochloric acid. For example, the organometallic sol-gel precursor is tetraethyl orthosilicate (TEOS) mixed with 1 M HCl.

Coupling Agent

The coupling agent is a liquid precursor, which induces covalent bonds between the organic and inorganic phases and reduces the size of the inorganic domains, crucial to obtain a high performance material. Coupling agents are hydrolyzable organosilane compounds or a mixture of compounds with the formula R₍₄₋ₙ₎SiXₙ where n is 1 to 3 and where X is independently a hydrolyzable group including C₁ to C₆ alkoxy, Cl, Br, I, hydrogen, C₁ to C₆ acyloxy, NR′R″ where R′ and R″ are independently H or C₁ to C₆ alkyl, C(O)R′″, where R′″ is independently H, or C₁ to C₆ alkyl. For the organic group containing precursor, R is independently C₁ to C₁₂ radicals, optionally with one or more heteroatoms, including O, S, NH, and NR″″ where R″″ is C₁ to C₆ alkyl or aryl, wherein the radical is non-hydrolyzable from the silane and contains a group capable of undergoing a polyaddition or polycondensation reaction, including Cl, Br, I, unsubstituted or monosubstituted amino, amino, carboxyl, mercapto, isocyanato, hydroxyl, alkoxy, alkoxycarbonyl, acyloxy, phosphorous acid, acryloxy, metacryloxy, epoxy, vinyl, alkenyl, or alkynyl.

A preferred coupling agent is methacryloxy(propyl)trimethoxysilane (MEMO).

In a preferred embodiment, the dual cure composition according to the invention comprises the following components:
A photo-curable hyperbranched monomer (preferably an acrylated hyperbranched polyester or polyether);
Inorganic particles (preferably metal oxides, such as silicon oxide, with sizes preferably in the range from 10 nm to 1 μm)
An organometallic (metal alkoxide) precursor in the form of M(OR)₄, where M is a metal (preferably Si or Ti) and R is an organic group, preferably in a water solution in presence of an acid such as HCl;
A coupling agent such as methacryloxy(propyl)trimethoxysilane (MEMO);
A photoinitiator with absorption spectrum adapted for the application process (visible light cure or UV cure) such as 1 -hydroxy-cyclohexyl-phenyl-ketone.

Another object of the invention concerns a hybrid nanocomposite material obtained from a dual cure composition according to the invention wherein said composition has been exposed to thermal energy and radiation.

The hybrid nanocomposite material is constituted of a solid particulate phase embedded in a hybrid organic/inorganic matrix phase.

The composition of the present invention can be calculated to reach a desired organic/inorganic ratio in the final hybrid nanocomposite material.

The process for preparing a hybrid nanocomposite material according to the invention comprises the following steps:
i) providing a first solution comprising a radiation curable polymer precursor;
ii) providing a second solution comprising a coupling agent and an organometallic precursor;
iii) mixing said first solution with said second solution;
iv) mixing the solution obtained in step iii) with solid particles to obtain a mixture;
v) exposing the mixture to thermal energy and radiation.

The first solution may furthermore comprise a photoinitiator.

The timing and details of the process sequence can be tuned in view of optimizing the overall process cycle time and properties of the cured material.

The preparation of the dual cure formulation uses appropriate amounts of precursors, which should be available and mixed as follows:
A first step, in the case of photopolymerization, is to mix or dissolve the appropriate selection or combination of photoinitiators (PI, usually 0.1 to 3 wt %, preferably 0.5-1 wt %, exceptionally more than 3 wt %) in the polymer precursor. Increasing the temperature and stirring with conventional means is often used for this step to facilitate mixing and dissolution.
A second step is to mix the coupling agent and the organometallic precursor diluted in water. The amount of water can be adjusted with respect to the number of functional groups of the organometallic precursor (for instance a molar ratio of water to ethyl groups equal to 1:2). The pH of the water solution can be adjusted towards an acidic value (using HCl for instance), a low pH with the use of a coupling agent enables a very fine intertwined organic/inorganic structure (few nm). The mixture is usually stirred at room temperature until homogenization is visually observed.
A third step is to mix the polymer precursor (with PI) with the solution prepared in step 2, and stir for sufficient time (30 min or more).
A fourth step is to mix the liquid obtained after step 3 with the particles and stir for sufficient time (30 min or more). Depending on the amount of particles, the application of mechanical energy (for instance using ultrasonication treatment) can be used to facilitate disagglomeration and dispersion. In the case the particles are initially in the form of a dispersion in a solvent, this step may include an evaporation step.

Curing of the formulation is a two-step ‘dual-cure’ process, comprising a condensation step and a radiation-curing step. Radiation curing is usually short (seconds), and performed once or several times in form of energy pulses for instance. It is carried out at room temperature (preferably in an oxygen free environment in the case of photopolymerization of free radical systems), but can also be done at higher temperatures. The condensation is usually carried out at temperatures below 100° C., under a controlled relative humidity. The timing of the dual-cure sequence can be tuned, as detailed in the preferred embodiments.

The exposure to radiation may be done before the exposure to thermal energy or after the exposure to thermal energy, or anytime during the exposure to thermal energy.

The exposures to thermal energy and radiation may be done alternatively.

The exposure to thermal energy may be done alternately with the exposure to radiation.

In a preferred embodiment, the first cure is a heat cure to carry out the sol-gel condensation reaction and the second cure is a UV cure to carry out the photopolymerization. The photopolymerization process can be performed before the sol-gel condensation, after the sol-gel condensation, or anytime during the sol-gel condensation process. The composition of the formulation can be adapted in order to reduce the condensation time and operate at lower temperatures, hence preserve the benefits of the fast and low-temperature character of the photopolymerization.

In a typical formulation the liquid hyperbranched monomers is first mixed with sol-gel precursors, coupling agent and photoinitiators, and second, nanoparticles are added to the mixture in proportions according to the desired final organic/inorganic composition.

In case photopolymerization is done before condensation, the low viscosity of the unreacted formulation facilitates processability. In addition a very fine inorganic network is ensured, due to the coupling agent that copolymerizes with the hyperbranched monomer and prevents macroscopic phase separation. However, during condensation high shrinkage may occur, due to the evaporation of byproducts, possibly leading to stress buildup issues such as distortion and cracking.

The preferred process is in fact a process where the photopolymerization is done after sol-gel condensation has started, or even after completion of the condensation process. If photo-polymerization is done before the completion of the condensation, a certain amount of byproduct can evaporate before a rigid network forms and shrinkage stress can relax in the still liquid polymer. This approach combines the advantages of a low viscosity for processing and the absence of damage. If photo-polymerization is done after completion of the sol-gel condensation, shrinkage from evaporation of byproducts occurs in a liquid material, hence no internal stresses develop and no cracks form. Moreover, the condensation of the metal alkoxide with metal oxide surfaces such as glass leads to very good adhesion. However, the processability of the composite material may be compromised, due to increased viscosity of the system.

The optimal timing for the photopolymerization may be found depending on the preferred balance of viscosity and process conditions. The overall process cycle sequence (total condensation time, process temperature, and timing of the photo-polymerization) may also be optimized based on the detailed composition of the formulation.

The hybrid organic/inorganic nanocomposites materials according to the invention obtained using the above-mentioned composition and dual-cure process are usually transparent and their thermo-mechanical properties are generally superior to those obtained using conventional solvent-assisted mixing processes with nanoparticles. Particularly, these materials develop extremely low stress levels during processing.

The hybrid nanocomposite material according to the invention is useful in a variety of applications. It may be used in a broad range of coating applications, in display applications including mobile communications, in microsystem technologies including biomedical device technologies and sensor technologies, in dentistry, in photovoltaic applications, etc.

### BRIEF DESCRIPTION OF THE DRAWINGS

The present invention will be described in detail with reference to the figures.

FIG. 1 shows a sketch of the low-stress hybrid nanocomposite material according to the invention based on inorganic particles (1) and a hybrid hyperbranched polymer/inorganic matrix (2) produced by sol-gel processing and photo-curing.

FIG. 2 illustrates a transparent 100 μm thick hybrid film formed from a hybrid material containing 20% vol of SiO₂ which covers the right side of the image.

FIG. 3 shows transmission electron micrographs of hybrid materials at a silica volume fraction of (a) 5% and (b) 20%.

FIG. 4 shows ²⁹Si-NMR data and deconvoluted peaks of a hybrid material at 20% vol inorganic phase.

FIG. 5 shows relative weight and derivatives as a function of temperature for a hybrid material (FIG. 5a) and a particulate nanocomposite (FIG. 5b) with different silica fractions (vol % as indicated).

FIG. 6 shows dynamic modulus E* for a hybrid material (full line) and for a particulate nanocomposite (dotted line) as a function of silica fraction φ.

FIG. 7 shows dynamic modulus E* for hybrid materials at different filler fractions φ, photopolymerized after different condensation periods.

FIG. 8 shows glass transition temperature T_{g} determined by DMA as a function of silica fraction φ for a hybrid material (full line) and for a particulate nanocomposite (dotted line).

FIG. 9 shows coefficient of thermal expansion for a hybrid material. The line represents the fit with the Thomas model. The dotted line shows the trend for the particulate nanocomposite.

FIG. 10 illustrates internal stress determined from beam bending experiments, using the model of Inoue, for hybrid materials as a function of silica fraction φ at 50 mW/cm². The dotted line represents the linear fit for the particulate nanocomposites.

FIG. 11 shows averaged AFM profiles of hybrid nanocomposite material gratings at φ=25% with photo-polymerization done after different condensation periods a) after 45 min, b) after 75 min, c) after 165 min, d) after 240 min. In all cases the total condensation time was 240 min with pressure 6 bar, UV intensity 50 mW/cm² and illumination time 300 s. The averaged profile of the glass master grating is shown in FIG. 11e).

FIG. 12 shows grating period as a function of condensation time before photo-polymerization at 25% vol of silica, and as a function of filler fraction with photo-polymerization done after 45 min. The line with the error bar represents the period of the replication master.

FIGS. 13a and 13b show grating dimensions for the hybrid nanocomposite as a function of (a) the length of the initial condensation period at a filler fraction of 25% vol and (b) at different silica fraction φ with photo-polymerization done after 45 min of condensation. Circular symbols: top dimension; triangular symbols: bottom dimension; square symbols: step height. The total condensation time was 240 min. Pressure 6 bar, UV intensity 50 mW/cm² and illumination time 300 s.

### DETAILED DESCRIPTION OF THE INVENTION

Hybrid low-stress materials were produced using a dual-cure process method with a composition comprising an acrylated hyperbranched monomer, TEOS as the sol-gel precursor and MEMO as a coupling agent, and their thermo-mechanical properties and stress were compared with the properties of a nanocomposite material obtained using a conventional solvent assisted mixing process.

Synthesis of a Hybrid Material

The hyperbranched monomer was based on a 3^{rd} generation hyperbranched polyether polyol, giving a 29-functional hyperbranched polyether acrylate (HBP, Perstorp AB, Sweden). The photoinitiator was 1-hydroxy-cyclohexyl-phenyl-ketone (Irgacure® 184, Ciba Specialty Chemicals). 1 wt % of photoinitiator was dissolved in the HBP while stirring at 70° C. in an oil bath for 30 min. Following references to HBP will always refer to the mixture of HBP with 1 wt % photoinitiator. Tetraethyl orthosilicate (TEOS, Sigma Aldrich) was used as a precursor and methacryloxy(propyl) trimethoxysilane (MEMO, Sigma-Aldrich) as a coupling agent. 1 M HCl in H₂O was purchased from Sigma-Aldrich. HBP, MEMO, TEOS and 1 M HCl in water were mixed together in this order. After each step the mixture was stirred at room temperature until homogenization was visually observed. After addition of the last compound the mixture was stirred for 30 min. The amount of TEOS was calculated assuming 100% conversion of the precursor into SiO₂. The amount of coupling agent was calculated to give a concentration of 10% methacrylic groups within acrylic groups. The conversion of the silanol groups into SiO₂ was also assumed to be 100%. The amount of H₂O was calculated to give a molar ratio of H₂O to ethyl groups equal to 1:2. Condensation of the inorganic phase was done at 80° C. for 4 h. Photo-polymerization of the HBP network was done either before, after or during condensation, using a 200 W high pressure mercury bulb (OmniCure 2000, Exfo, Canada) in combination with a liquid light guide. The light intensity on the sample was set at at 50 mW/cm² as measured using a spectrometer (Sola-Check, Solatell, UK) over the range of 270 to 470 nm.

Synthesis of a Particulate Nanocomposite

The hybrid organic/inorganic material was compared with a particulate composite obtained by mixing a 30 wt % monodispersed suspension of SiO₂ in isopropanol, with an average SiO₂ particle size of 13 nm (Highlink NanO G502, Clariant) with the HBP for 30 min at room temperature. The solvent was removed at 40° C. under vacuum until no more weight change was recorded. Films of 100-400 μm in thickness were subsequently photo-polymerized at 50 mW/cm².

Comparison Between the Hybrid Material and the Particulate Nanocomposite

The microstructure of the nanocomposites was investigated by TEM (Philips/FEI, CM20 at 200 kV). The samples were embedded in an epoxy resin (Epoxy resin medium kit, Fluka) and cut with a diamond knife on a microtome (Ultracut E, Reichert-Jung) to 40 nm thick slices, then put on a carbon coated grid. The SiO₂ weight content and the thermal stability were measured in a thermo-gravimetric analyzer (TGA, SDTA851, Mettler Toledo). The weight loss was recorded while the samples were heated from ambient temperature to 800° C. at 10 K/min. The condensation of the inorganic phase was measured by solid-state ²⁹Si-NMR (Avance 400, Bruker). The spectra were obtained at 59.62 MHz and the solid samples were ground prior to analysis. NMR spectra were deconvoluted using Gaussian fits in terms of Qᵢ where i=2, 3, 4 correspond to the number of siloxane bridges bonded to the silicon atom of interest. The condensation state Ω was calculated according to:

$$Ω = {\sum }_{i = 2}^{4} \frac{i}{4} {Q}_{i} = \frac{1}{2} {Q}_{2} + \frac{3}{4} {Q}_{3} + {Q}_{4}$$

The viscosity of the unpolymerized samples was recorded using an strain-controlled rotational rheometer (ARES, Rheometrics Scientific). For the particulate composites a cone-plate geometry with a diameter of 25 mm, a cone angle of 0.1 rad and a gap of 0.051 mm was used. Due to the low viscosity of the mixtures containing the sol-gel precursor, measurements were done with a couette geometry using a cylinder diameter of 25 mm, cylinder length of 32 cm and wall space of 1 mm. The strain was ensured to be in the linear viscoelastic range at any frequency. The glass transition temperature T_{g} was determined by means of differential scanning calorimetry (DSC, Q100, TA Instruments) at a heating rate of 10 K/min between −20 and +100° C. The tensile modulus and the transition temperature were measured in a dynamic mechanical analyzer (DMA, Q800, TA Instruments) under axial oscillatory deformation at a frequency of 1 Hz and an axial elongation of max. 0.15% strain during heating from room temperature up to 150° C. at a rate of 10 K/min. The coefficient of thermal expansion (CTE) was measured with a thermo-mechanical analyzer (TMA 402, Netsch) using a heating and cooling rate of 5 K/min. The in-plane internal stress σᵢ of composite films was determined from the curvature of coated aluminum beams, and calculated according to the model of Inoue

$${σ}_{i} = - \frac{{E}_{s} {h}_{s}^{2}}{6 {rh}_{c}} ( \frac{\begin{matrix}{( 1 - {uq}^{2} )}^{3} ( 1 - u ) + {( uq ( q + 2 ) + 1 )}^{3} + \\ {u ( {uq}^{2} + 2 q + 1 )}^{3}\end{matrix}}{2 ( 1 + q ) {( 1 + uq )}^{3}} )$$

$$with u = \frac{{E}_{c}}{{E}_{s}} and q = \frac{{h}_{c}}{{h}_{s}} ,$$

where Eₛ and E_{c} are the moduli of the substrate and the composite, respectively, r is the radius of curvature, and hₛ and h_{c} are the thickness of the substrate and the composite.

Process-Microstructure Relations

The hybrid organic/inorganic materials were produced using a dual cure process method, comprising condensation and photopolymerization, which were carried out using different timings for the photopolymerization (either before, after, or at a certain time during the condensation). In all cases, condensation lasted in total 4 h.

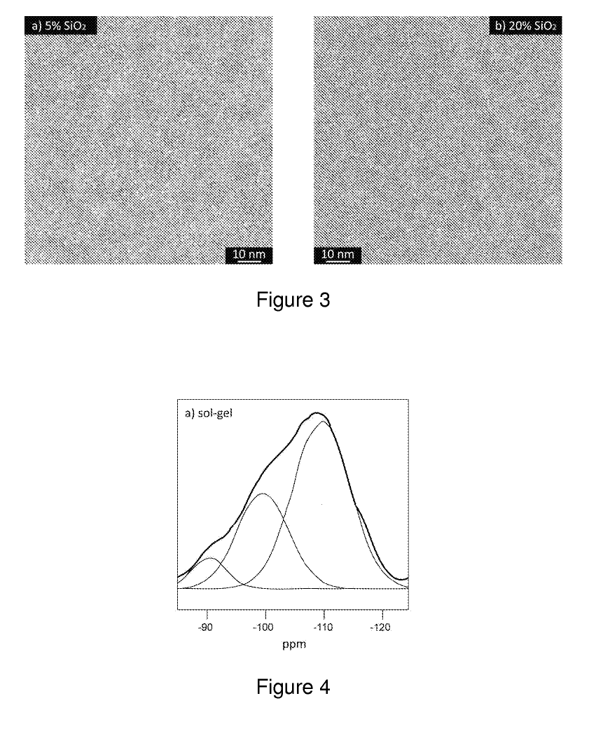

In all cases the hybrid materials remained completely transparent (FIG. 2), as did the particulate composites. FIG. 3 shows the TEM micrographs of the hybrid materials with two different compositions. No phase contrast can be seen due to a very fine silica network promoted by the coupling agent that copolymerized with the HBP network and prevented macroscopic phase separation of the forming silica.

Thermo-gravimetric analysis summarized in Table 1 confirmed the presence of a non-volatile phase in the hybrid material close to the theoretical amount of silica, if the HBP residue was subtracted. The presence of a silica phase was further confirmed by solid state ²⁹Si-NMR (FIG. 4). The deconvoluted spectra gave signals at approximately −92, −102 and −113 ppm. The position of the peaks corresponded to Q₂, Q₃ and Q₄ species, respectively. The condensation state Ω of the sol-gel silica was calculated to be equal to 84%, with a majority of Q₄ species, as opposed to 89% for the Highlink particles. The lower condensation state was presumably due to the presence of the coupling agent, which can form maximum three Si—O bonds, which corresponds to the Q₃ state.

TABLE 1
Non-volatile residues from TGA for HBP/silica nanocomposites
produced by sol-gel process

| Sample | HBP | φ = 5% | φ = 20% |
|---|---|---|---|
| Theoretical volume fraction | 0 | 5 | 20 |
| of inorganic phase (%) | | | |
| Theoretical weight fraction | 0 | 8.7 | 31.1 |
| of inorganic phase (%) | | | |
| Measured weight residue | 1.5 | 10.2 | 33.8 |
| (%) | | | |
| Calculated volume fraction⁽*⁾ | — | 4.5 | 19.3 |

⁽*⁾The weight residue of the HBP was subtracted from the residue of the composites.

Thermo-Mechanical Properties

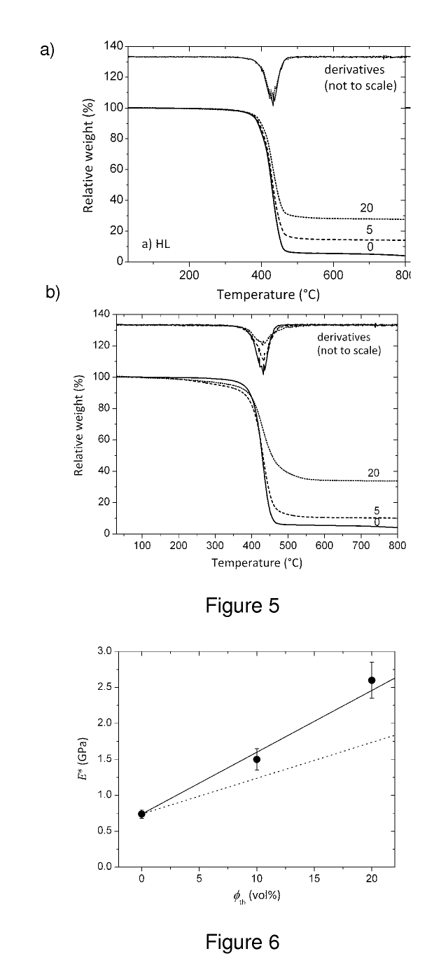

FIG. 5 shows the thermo-gravimetric curve of the HBP and the two types of nanocomposites. The HBP network was stable up to approximately 400° C., above which thermal degradation occurred in one step (one single derivation peak). The thermal stability of the particulate composites was only marginally improved with the addition of SiO₂. For the hybrid materials, the weight loss at temperature T<400° C. was presumably due to evaporation of trapped side products or due to finalization of incomplete condensation. The more distinct weight loss at T≈400° C., corresponding to the degradation of the polymer network, occurred at the same temperature as for the pure HBP.

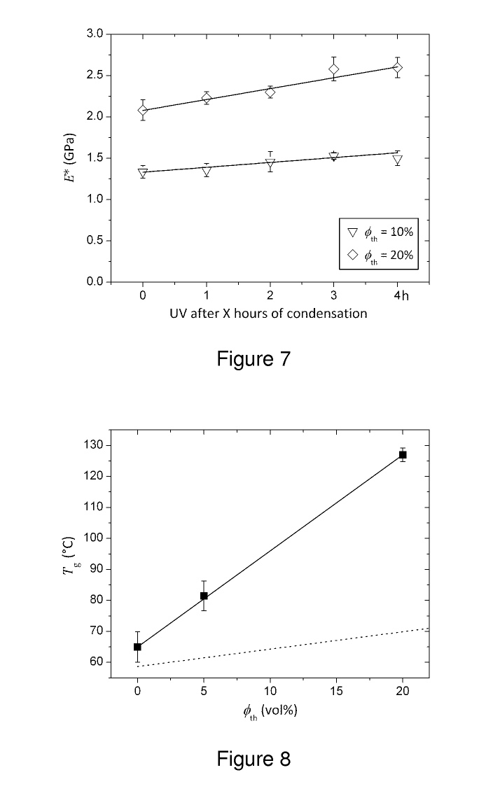

FIG. 6 shows the dynamic moduli E* for the particulate and the hybrid materials. In the latter case the “UV first” process was chosen, but the processing sequence for the hybrid materials only had a minor influence on the values of E*, as is demonstrated in FIG. 7. For both the particulate and the hybrid materials the modulus was proportional to the filler fraction, but higher in the case of the hybrid materials. This strengthens the assumption that the inorganic phase was in the form of a fine 3-dimensional silica network, which was able to immobilize the surrounding polymer more effectively than the discrete particles.

The glass transition temperature T_{g} as determined from calorimetric experiments was around 9° C. for the HBP and the particulate composite, i.e. the silica particles did not have an influence on the T_{g}. For the hybrid materials the T_{g} could not be determined, since no step in the heat capacity was observed. This is generally related to complete immobilization of the polymer matrix by the inorganic phase in the form of a fine inorganic network structure with very high specific surface area. FIG. 8 shows the glass transition temperature determined from dynamic mechanical analysis T_{g,DMA}, that increased linearly with the filler fraction for both types of composites. At φ=20% the T_{g,DMA} of the hybrid materials was equal to 130° C., which was considerably higher than that of the particulate composites at 70° C. Hence, mechanical stability is given up to significantly higher temperatures for the hybrid materials.

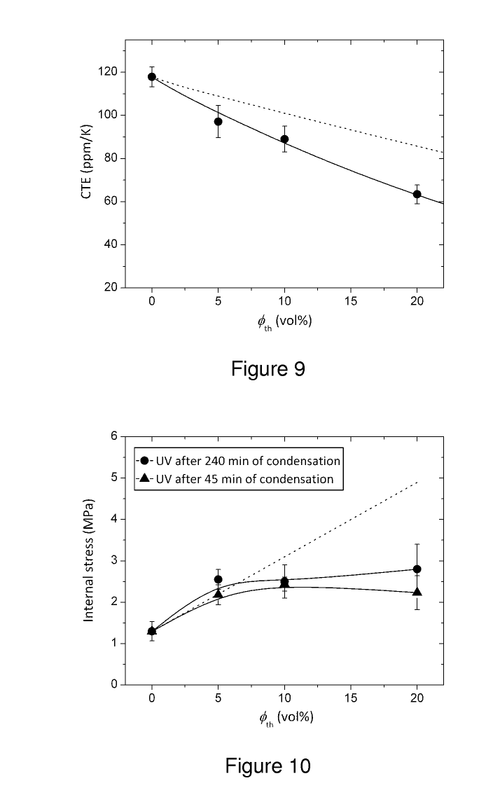

FIG. 9 shows the coefficient of thermal expansion (CTE) that reduces with increasing amount of silica. Correlating with the higher T_{g,DMA} and E* for the hybrid materials with respect to the particulate composites, the CTE is 25% lower for the hybrid materials at φ=20%.

Internal Stress

FIG. 10 shows the residual stress of the particulate and the hybrid materials. Calculations were done with the model of Inoue, using the modulus values of the materials produced under the same conditions. For the particulate composites the internal stress was linearly increased with the filler fraction. This was due to the increased stiffness of the material, which outplayed the reduced polymerization shrinkage of such materials.

The hybrid materials were produced according to the “condensation first” procedure (UV after 240 min of condensation) and with photo-polymerized done after 45 min of condensation. For samples prepared following the “UV first” procedure, the internal stress could not be measured, due to cracking of the material.

It is evident that the stress doubled from φ=0 to 5%, beyond which it remained constant. No difference was observed between photopolymerization after 45 or 240 min. At φ>5% considerably less stress developed for the hybrid materials than for the particulate composites for a given amount of silica. As an example, at φ=20% stress reduction by a factor of 2.2 was measured with respect to the particulate composites.

After 45 min the condensation was incomplete, i.e. the precursor was only partially transformed into SiO₂. At that stage, the inorganic phase yet only showed reduced reinforcing effect, and the HBP was still swollen (i.e. plasticized) with liquid precursor. Therefore, polymerization shrinkage occurred in a less stiff material than was the case for the particulate composites. Hence, shrinkage stress was able to relax in the still soft network. For the “condensation first” case, the precursor was completely transformed into solid SiO₂ and the byproducts were evaporated before the beginning of the photo-polymerization reaction. Therefore, similar reinforcing effect and stiffness could be expected for the hybrid materials as for the particulate composites. The reason for the considerably reduced internal stress could therefore result from reduced polymerization shrinkage, which was not measured for these materials due to evaporation phenomena. As the silica was in the form of a fine inorganic network, shrinkage of the intertwined polymer was presumably restricted by the rigid inorganic network structure.

As summarized in Table 2, all thermo-mechanical properties were improved with the addition of silica and the improvement was more pronounced for the hybrid materials compared to the conventional solvent processed nanoparticulate composites. This was due to the very fine silica structure, leading to a higher specific HBP/SiO₂ interfacial area than in the particulate composites.

TABLE 2
Comparison of hybrid materials and nanoparticle composites with 20%
silica fraction. Values were taken at room temperature, where applicable.

| | Viscosity | | | | |
|---|---|---|---|---|---|
| HBP + 20% | η | Young's | CTE | T_{g,DMA} | σᵢ |
| silica | (Pa · s) | modulus E* | (ppm/° C.) | (° C.) | (MPa) |
| Hybrid | 1.3 · 10⁻² | 2.6 | 63 | 127 | 2.2 |
| Nanoparticles | 2 · 10⁵ | 1.7 | 84 | 69 | 4.9 |

In a second preferred embodiment, nanograting surface structures were produced using the dual-cure method and a range of hybrid formulations. Nanogratings and more generally nanotextures are used to tailor optical properties of surfaces. Examples are found in optical chips and in textured coatings with enhanced light scattering for photovoltaic applications.

A nanoimprint lithography tool comprising a UV-transparent quartz window and a dry etched glass grating master with a period of 360±1 nm and a depth of 12±1 nm was used to produce selected nanogratings. This particular grating structure is used in wavelength-interrogated optical sensors (WIOS) used for immunoassay purposes.

The hybrid formulation was the same as the one detailed in the previous embodiment, with up to 25% vol silica. The material to imprint was dispersed on the master and covered with a glass slide, the surface of which was treated with methacrylsilane to improve adhesion. Pressure was applied while the material was polymerized through the quartz window. Approximately 12% of UV light was absorbed through the glass carrier. The UV intensities reported in the following were measured under the glass carrier, i.e. on the surface of the hybrid material. After polymerization the pressure was released and the master was removed from the imprinted material attached to the glass carrier. No special surface treatment was needed to help demolding, due to the 25° clearance angle of the glass grating. The topography of the gratings was analyzed by atomic force microscopy (AFM, Multimode II, Veeco) in contact mode using a tip with a spring constant of 0.06 N/m. 512 scans were recorded over a length of 2 μm and an average profile was calculated.

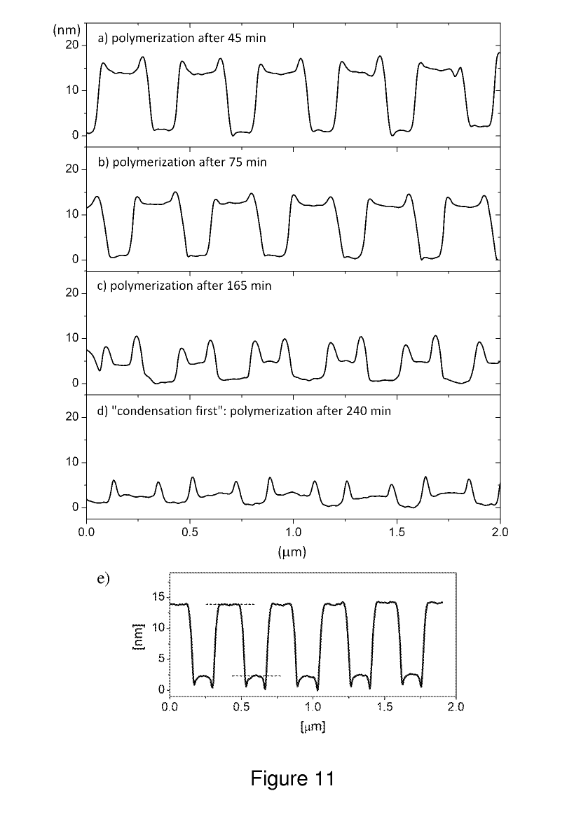

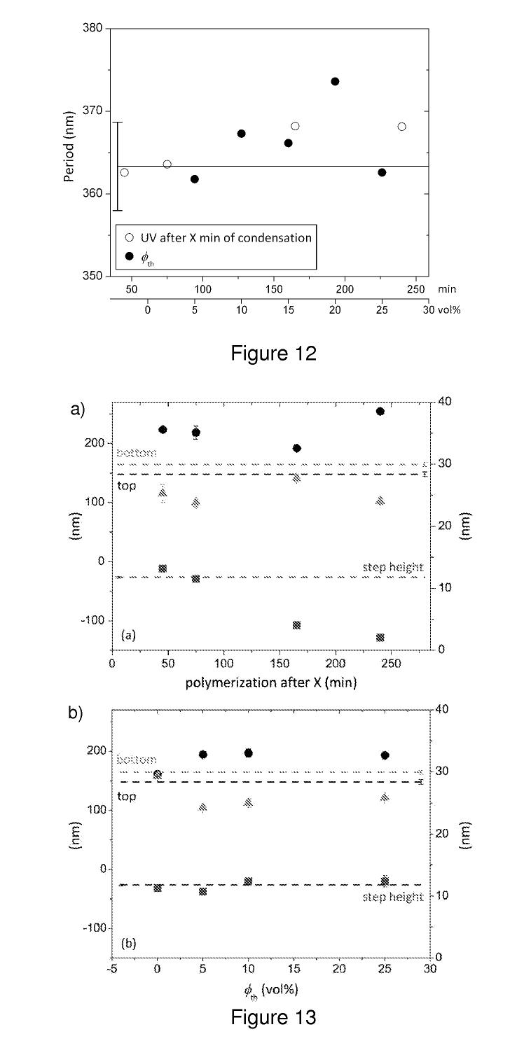

A critical parameter to control is the timing of the photopolymerization reaction with respect to the condensation reaction. “UV first” systematically led to excessive deformation and cracking of the sample during condensation. “Condensation first” led to stable gratings, however with poor replication fidelity, as shown in FIG. 11d. Another possibility that was explored was to perform the photo-polymerization reaction after a certain condensation time, and then continue the condensation to completion. Total condensation time in all cases was 240 min. FIG. 12 shows the averaged profiles of hybrid materials gratings prepared accordingly. The grating period was nearly preserved with fidelity better than 95% (FIG. 12). However, the step height progressively degraded and almost completely disappeared, when the condensation time before photopolymerization increased. FIG. 13a shows the average step height measured from the grating profiles in FIG. 11. Again, it is obvious that the longer the initial condensation period, the smaller was the step height. The shape fidelity of the step height in case photo-polymerization was done after condensation was only 20%, giving an overall shape fidelity of about 19%. The reason for this was the high amount of silica that formed in the shape of a rigid 3-dimensional network and that could not be deformed with the maximum pressure of the NIL tool (6 bar). After 45 min of condensation the composite had already relaxed an important amount of evaporation shrinkage stress, but the silica network was still sufficiently soft to be imprinted by the replication master at 6 bar. Hence, the step height was 12 nm, which was equal to the master step height. FIG. 13b shows the top and bottom dimensions as well as the step height for different silica fractions φ, with photo-polymerization reaction performed after 45 min. It is evident that for φ≧5% the top and bottom dimensions were constant, but deformed with respect to the master. Since the internal stress level was also constant for φ≧0 5%, these results confirm that the grating distortion was indeed a function of the internal stress level in the material. The scatter in the step height was because different masters were used with differences in step height up to ±1 nm.

To summarize, hybrid HBP/silica nanocomposites were prepared using a dual-cure process based on an in situ sol-gel method and photo-polymerization. The dual-cure process sequence was optimized to avoid premature cracking of the material due to excess evaporation. Nano-sized gratings were produced from sol-gel HBP hybrids with up to 25% silica by nanoimprint lithography in a rapid low-pressure process using a glass master. The dual-cure process was optimized in terms of timing of photo-polymerization and condensation. The period of the composite gratings was within 95% with respect to the master period. The highest fidelity was achieved with 45 min of condensation, followed by 90 s of photo-polymerization, and then completion of the condensation reaction lasting 195 min.

The present low viscosity hybrid formulations offer improved processability and their dual-cure process leads to hybrid materials with improved thermo-mechanical properties and lower internal stress compared to particulate composites. The dual-cure process method is compatible with nanostructuration processes such as nanoimprint lithography. The dual-cure process based on optimized HBP and sol-gel precursor formulation thus enables to produce nanostructures with exceptional shape fidelity in a hybrid material with very high thermo-mechanical stability.

Hybrid Nanocomposite Material According to the Invention

A third embodiment is a hybrid formulation including both nanoparticles and sol-gel precursors. It comprises the following components:
A hyperbranched monomer based on a 16-hydroxyl functional 2nd generation hyperbranched polyester (HBP Boltorn® H20, Perstorp AB, Sweden) giving a 13-functional polyester acrylate,
A photoinitiator (1-hydroxy-cyclohexyl-phenyl-ketone, Irgacure® 184, Ciba Specialty Chemicals),
Tetraethyl orthosilicate (TEOS, Sigma Aldrich),
Methacryloxy(propyl) trimethoxysilane (MEMO, Sigma-Aldrich),
A suspension of 13 nm diameter SiO₂ nanoparticles in isopropanol (Highlink Nano G502, Clariant)

Notice that inorganic particles with a distribution of particle sizes is preferred to reach high volume fraction of particles.

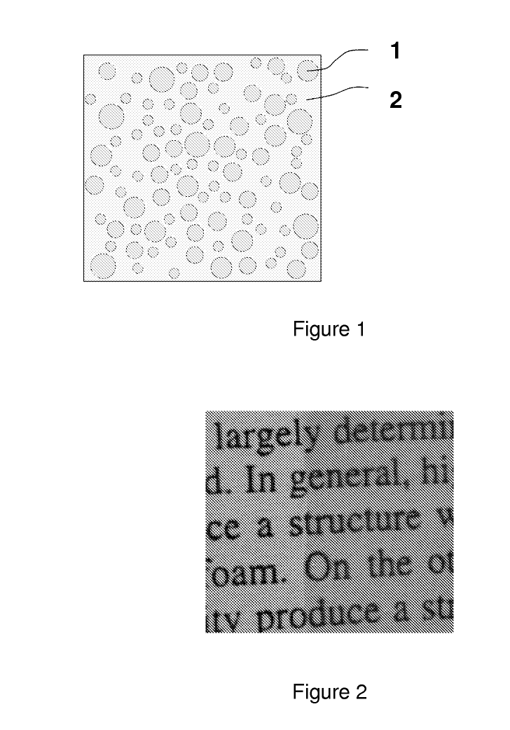

FIG. 1 shows the microstructure of the low stress hybrid nanocomposite material according to the invention.

The composition of the formulation was calculated to reach a desired organic/inorganic ratio in the final hybrid material. Four different compositions were formulated to reach a fraction of inorganic phase in the range from 40%wt to 80%wt as summarized in Table 1. The inorganic fraction comprised the fraction of SiO₂ particles (8.5% to 34%) plus the fraction of silica resulting from the condensation of the TEOS precursor (32% to 46%; a 100% conversion of the TEOS precursor into SiO₂ was assumed). The amount of coupling agent was calculated to give a concentration of 10% methacrylic groups within acrylic groups. The amount of H₂O was calculated to give a molar ratio of H₂O to ethyl groups equal to 1:2.

TABLE 1
Composition of the hybrid formulations [% wt]

| | Formulation | Formulation | Formulation | Formulation |
|---|---|---|---|---|
| Component | #1 | #2 | #3 | #4 |
| HBP | 53.6 | 34.6 | 32.7 | 17.6 |
| Photoinitiator | 1.0 | 1.0 | 1.0 | 1.0 |
| SiO₂ particles | 8.5 | 15.3 | 36.2 | 33.8 |
| TEOS | 31.8 | 46.0 | 27.2 | 45.6 |
| MEMO | 5.1 | 3.1 | 2.9 | 2.0 |
| Inorganic | 40.3 | 61.3 | 63.4 | 79.4 |
| fraction [% wt] | | | | |

In a first step, the photoinitiator (1% wt) was dissolved in the monomer while stirring at 70° C. in an oil bath for 30 min. In a second step, MEMO, TEOS and 1 M HCl in water were mixed together with the HBP in this order. After each step the mixture was stirred at room temperature until homogenization was visually observed. After addition of the last compound the mixture was stirred for 30 min. The formulation was mixed in a third step with the Highlink suspension of SiO₂ nanoparticles for 30 min at room temperature.

Condensation of the inorganic phase was done at 40° C. (under 50% RH and 90% RH) for all formulations and also at 30° C. (under 50% RH and 90% RH) and 80° C. (under 50% RH) for formulations #1 and #4. Photo-polymerization of the HBP network was done either during or after condensation, using a 200 W high pressure mercury bulb (OmniCure 2000, Exfo, Canada) in combination with a liquid light guide. Films of 100-400 μm in thickness were photo-polymerized at 50 mW/cm2.

In all cases the hybrid materials remained completely transparent. Their properties were systematically improved with respect to the composite with nanoparticles, but without TEOS (see data in Table 2), and depended on the process conditions. The condensation time at low temperature could be adjusted to ensure full condensation, prior to UV curing.

The present low viscosity hybrid formulations based on a combination of inorganic particles and sol-gel precursors in a light-curable hyperbranched monomer offer improved processability and their dual-cure process leads to hybrid materials with improved thermo-mechanical properties and lower internal stress compared to particulate composites.

1. A dual cure composition comprising
a) a radiation curable polymer precursor,
b) solid particles,
c) an organometallic precursor,
d) a coupling agent.

2. The dual cure composition according to claim 1 furthermore comprising a photoinitiator.

3. The dual cure composition according to claim 1, wherein said radiation curable polymer precursor is selected from the group of acrylates, methacrylates, urethane acrylates, unsaturated polyesters, thiol-enes, epoxides and vinylethers.

4. The dual cure composition according to claim 1, wherein said radiation curable polymer precursor is an hyperbranched polymer.

5. The dual cure composition according to claim 1, wherein said particles are inorganic particles.

6. The dual cure composition according to claim 5, wherein the inorganic particles comprise a metal oxide or a metal.

7. The dual cure composition according to claim 1, wherein said particles are organic particles.

8. The dual cure composition according to claim 7, wherein the organic particles comprise carbon, cellulose or cellulose derivatives.

9. The dual cure composition according to claim 1, wherein said organometallic precursor is a sol-gel precursor.

10. The dual cure composition according to claim 9, wherein the sol-gel precursor is a metal alkoxide.

11. The dual cure composition according to claim 1, wherein the coupling agent is a hydrolysable organosilane compound.

12. The dual cure composition according to claim 2, wherein said photoinitiator is selected from the group consisting of an alpha-diketone, a benzoin alkyl ether, a thioxanthone, a benzophenone, an acylphosphinoxide, an acetophenone, a ketal, a titanocene, a borate or a sensitizing colorant.

13. The dual cure composition according to claim 2, wherein, the radiation curable polymer precursor is a hyperbranched monomer based on a 16-hydroxyl functional 2nd generation hyperbranched polyester giving a 13-functional polyester acrylate, the solid particles are a suspension of SiO₂ nanoparticles in isopropanol, the organometallic precursor is tetraethyl orthosilicate (TEOS), the coupling agent is methacryloxy(propyl) trimethoxysilane (MEMO), the photoinitiator is 1-hydroxy-cyclohexyl-phenyl-ketone.

14. A hybrid nanocomposite material obtained from a dual cure composition according to claim 1, wherein said composition has been exposed to thermal energy and radiation.

15. A process for preparing a hybrid nanocomposite material according to claim 14 comprising the following steps:
i) providing a first solution comprising a radiation curable polymer precursor;
ii) providing a second solution comprising a coupling agent and an organometallic precursor;
iii) mixing said first solution with said second solution;
iv) mixing the solution obtained in step iii) with solid particles to obtain a mixture;
v) exposing the mixture to thermal energy and radiation.)

16. Process according to claim 15, wherein the first solution furthermore comprises a photoinitiator.

17. Process according to claim 15, wherein the exposure to thermal energy is done before radiation.

18. Process according to claim 15, wherein the exposure to thermal energy is done after radiation.

19. Process according to claim 15, wherein the exposures to thermal energy and radiation are done simultaneously.

20. Process according to claim 15, wherein the exposure to thermal energy is done alternately with the exposure to radiation.

21. Process according to claim 16 wherein the photoinitiator is 1-hydroxy-cyclohexyl-phenyl-ketone, the radiation curable polymer precursor is a hyperbranched monomer based on a 16-hydroxyl functional 2nd generation hyperbranched polyester giving a 13-functional polyester acrylate, the organometallic precursor is tetraethyl orthosilicate (TEOS), the coupling agent is methacryloxy(propyl) trimethoxysilane (MEMO), the solid particles are a suspension of SiO₂ nanoparticles in isopropanol.

22. Use of the hybrid nanocomposite material according to claim 14 in coating applications.

23. Use of the hybrid nanocomposite material according to claim 14 in display applications including mobile communications.

24. Use of the hybrid nanocomposite material according to claim 14 in microsystem technologies including biomedical device technologies and sensor technologies.

25. Use of the hybrid nanocomposite material according to claim 14 in dentistry.

26. Use of the hybrid nanocomposite material according to claim 14 in photovoltaic applications.
